(19) United States
(12) Patent Application Publication
(10) Pub. No.: US 2002/0119275 A1
(43) Pub. Date: Aug. 29, 2002

(54) Modular mats and edging system therefor

(76) Inventor: Jon L. Williamson, LaGrange, GA (US)

Correspondence Address: MILLIKEN & COMPANY, 920 MILLIKEN RD, PO BOX 1926, SPARTANBURG, SC, 29304, US

(21) Appl. No.: 09/503,700

(22) Filed: Feb. 14, 2000

(51) Int. Cl. B32B 3/10; B32B 3/02

(52) U.S. Cl. 428/44; 428/45; 15/215; 15/217; 15/392

(57) ABSTRACT

The present invention is a mat system, having two embodiments, each of which are capable of removing the dirt from the soles of mat users' shoes. The mats are comprised of a plurality of individual tiles that interlock along complementary edge portions. One embodiment of the mat system is a thermoplastic elastomer (TPE) mat that has a plurality of projections that remove dirt. The second embodiment, also having a TPE structure and a lesser number of projections, features several carpet strips that provide additional dirt removal means. Once the individual tiles are connected, the outermost complementary edges may be covered by a plurality of border strips that provide an aesthetically pleasing and functionally necessary finished edge to the mat. The border strips are secured to one another by a mechanical clip that is also described.

### TECHNICAL FIELD

This invention relates to a system of interconnecting individual tiles, each in the form of a lattice, from which dirt-gathering floor mats can be constructed, and to an edging system for such floor mats.

### BACKGROUND

It is well known to place floor mats at the entrances to buildings such as dwellings and offices, for scraping and wiping the undersides of the footwear of the persons entering the buildings for the purpose of minimizing the extent to which dirt and debris are brought into the buildings' interior spaces. These mats may be made of textile or non-textile materials (such as rubber), and may have either an open or solid construction. These mats may also include projections or raised projections capable of removing dirt from the feet of people walking over the mat surface. Scraper mats, which typically have a plurality of such projections, are often employed for reducing levels of dirt and mud carried on footwear in locations such as office buildings, personal dwellings, and agricultural and industrial complexes.

It is also known for scraper mats to be formed of mutually interlocking tiles such that mats in a wide range of lengths and widths can be assembled from an appropriate number of identical tiles. However, mats assembled from tiles that mutually interlock along their edges leave the outer edges of the assembled mats unfinished in terms of lacking a distinct boundary strip. These unfinished edges also present raised edges that may present a trip hazard unless the mats are appropriately recessed into the floor surface.

### SUMMARY

The present invention is a mat system having two embodiments, each of which is capable of removing the dirt from the soles of footwear. The mats are comprised of a plurality of individual tiles that interlock along complementary edge portions. One embodiment of the mat system is a thermoplastic elastomer (TPE) mat that has a plurality of finger-shaped projections that remove dirt. The second embodiment, also having a TPE structure and a fewer number of projections, features several textile components (e.g., carpet strips) that provide additional dirt removal means. Once the individual tiles are appropriately connected, the outermost complementary edges may be covered by a plurality of border strips that provide an aesthetically pleasing and functionally useful finished edge to the mat. The border strips are secured to one another by a mechanical clip that will also be described herein.

According to a first aspect of the present invention, there is provided a mat comprised of a plurality of individual, congruent tiles, wherein the mat tiles feature edges that are adapted to accommodate, alternatively, the attachment of adjacent tiles and the edging system that will be described herein. The tiles are comprised of a monolithic lattice made from a thermoplastic elastomer (TPE) that is recyclable and has other beneficial characteristics that will be made apparent. In one embodiment of this first aspect, the mat is comprised of tiles that are comprised of TPE. In a second embodiment of this first aspect, the mat is comprised of tiles that include a textile component that is incorporated onto the lattice structure of the tile. The textile component, such as a carpet tile, can take the form of strips that are held in place by a plurality of carpet clips that are integrated in the TPE structure. These integrated clips will be discussed in further detail herein.

According to a second aspect of the present invention, a border system is provided that comprises a plurality of border strips that attach to the edges of the individual tiles comprising the mat and that serve as a functional and aesthetic border to the mat. The attachment of the border strips is achieved through a plurality of components that are formed to cooperatively connect with complementary components of the mat. The border strip is a molded thermoplastic elastomer and has other beneficial features that will be described herein.

According to a third aspect of the present invention, there is provided an edged mat, the edged mat being comprised of a plurality of individual, interlocking tiles that are collectively surrounded by a plurality of border strips. The resulting edged mat may include textile components in addition to the thermoplastic elastomer structure. The border strips have a slightly beveled edge at the outermost portion of the strip that meets the floor, increasing the tendency of the border to lay flat on the floor. This feature is significant, in that a mat edge that does not closely and consistently align itself with the floor presents a trip hazard for mat users.

According to a fourth aspect of the present invention, a mechanical clip is provided that is capable of securing adjacent border strips to one another. The mechanical clip, which is comprised of glass-filled nylon and includes serrated teeth and spring-loaded jaws, is positioned over slightly recessed areas that are integrated into the back of the border strips. The mechanical clip may be used to secure the corner portions of the border strips or, in the case of larger mats, to secure one length of border strip to another length of border strip in abutting relationship.

According to the fifth aspect of the present invention, a kit of parts is provided that includes the parts required to assemble an edged mat, specifically including a plurality of individual tiles, a plurality of “male” border strips, a plurality of “female” border strips, and a plurality of mechanical clips.

### BRIEF DESCRIPTION OF THE DRAWINGS

Embodiments of the invention will now be described by way of example, with reference to the accompanying drawings wherein:

FIG. 1 is an overhead, or plan, view of the face surface of a tile that is part of a scraper mat, in which the entire tile structure is comprised of TPE;

FIG. 2 is an overhead, or plan, view of the back surface of the scraper mat tile of FIG. 1;

FIG. 3 is an overhead, or plan, view of the face surface of a tile that incorporates a textile component into the TPE structure;

FIG. 4 is an overhead, or plan, view of a plurality of the tiles of FIG. 3 that are joined in edge-wise fashion with one another, showing the addition of border strips along two edges;

FIG. 5 is a cross-sectional view of the textile brush mat of FIG. 4, as taken along line 5-5;

FIG. 6 is a plan view of a corner portion of the back surface of the intersection of two adjacent border strips, showing the placement of a mechanical clip used to secure the border strips;

FIG. 7 is a cross-sectional view of the mechanical clip shown in FIG. 6;

FIG. 8A is a plan view of the face surface of the “male” border strip that co-acts in complementary fashion with the “female” edge portions of the mats of FIGS. 1 and 2;

FIG. 8B is a plan view of the back surface of the “male” border strip of FIG. 8A;

FIG. 9 is a cross-sectional view of the border strip of FIG. 8B as taken along line 9-9;

Fig. 10A is a plan view of the face surface of the “female” border strip that co-acts in complementary fashion with the “male” edge portions of the mats of FIGS. 1 and 2;

FIG. 10B is a plan view of the back surface of the “female” border strip of FIG. 10A;

FIG. 11 is a cross-sectional view of the border strip of FIG. 10A as taken along line 11-11; and

FIG. 12 is a cross-sectional view of the border strip of FIG. 10A as taken along line 12-12, and showing a cross-sectional view of a socket.

### DETAILED DESCRIPTION

For purposes of discussion herein, a “mat” shall be defined as a covering for the floor or ground that is typically placed outside or immediately inside an entryway, the mat being capable of removing dirt from the soles of mat users' shoes. The term “mat” is meant to encompass those coverings that have borders around their perimeter edges in accordance with one embodiment described herein, and also to encompass those coverings in which the perimeter has been modified for installation into a recessed area in the floor, such as a mat holding well, or for wall-to-wall installation into a foyer or other entryway.

To further describe the present invention, the following terms are used. The term “male” refers to those edge portions of the mats and border strips that have a peg component. The term “female” refers to those edge portions of the mats and border strips that have a socket component that is sized and spaced to accommodate the “male” peg component. The “male” and “female” components are “complementary” to one another, in the sense that the “male” components may be securely inserted into the “female” components in lapped relation, in a way that provides a mechanism for holding adjacent tiles to one another, and also for holding individual tiles to adjacent border strips. For aesthetic purposes, the face side of the “male” component includes the same finger-like projections that are employed in the body of the mat.

The term “face” shall refer to the upwardly directed surface of the mat that contacts the shoes of people walking on the mats. The “body” of each mat tile is the bulk of the mat tile between and bounded by the interlocking edges, and is molded in an open lattice construction, with upwardly directed finger-like projections that dislodge dirt from the soles of mat users' shoes. In the case of textile brush mats, the body also includes carpet strips. The term “back” refers to the surface of the mat, opposite the face, that is in contact with the floor or ground.

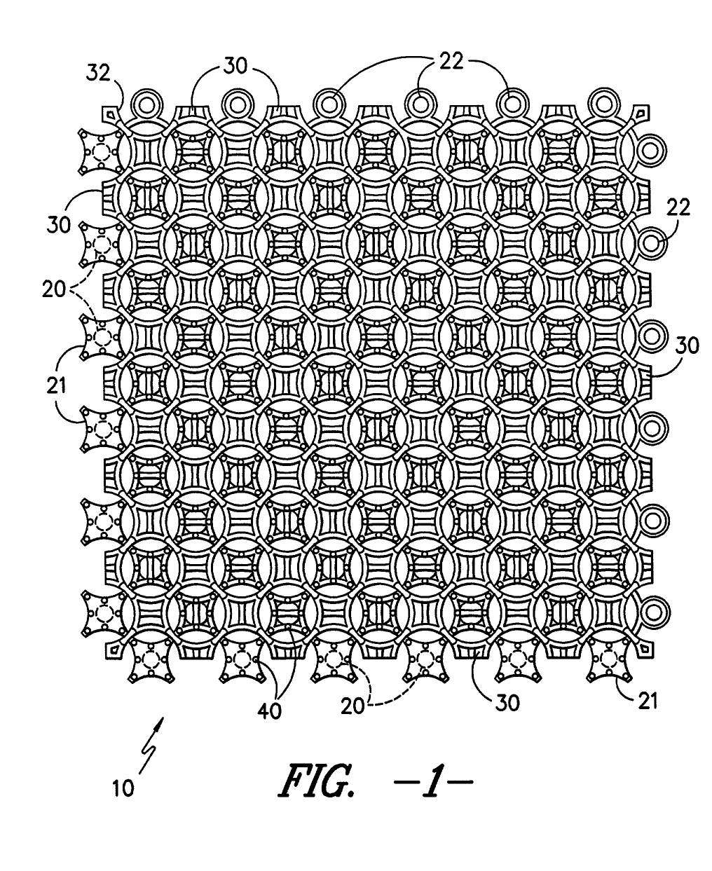

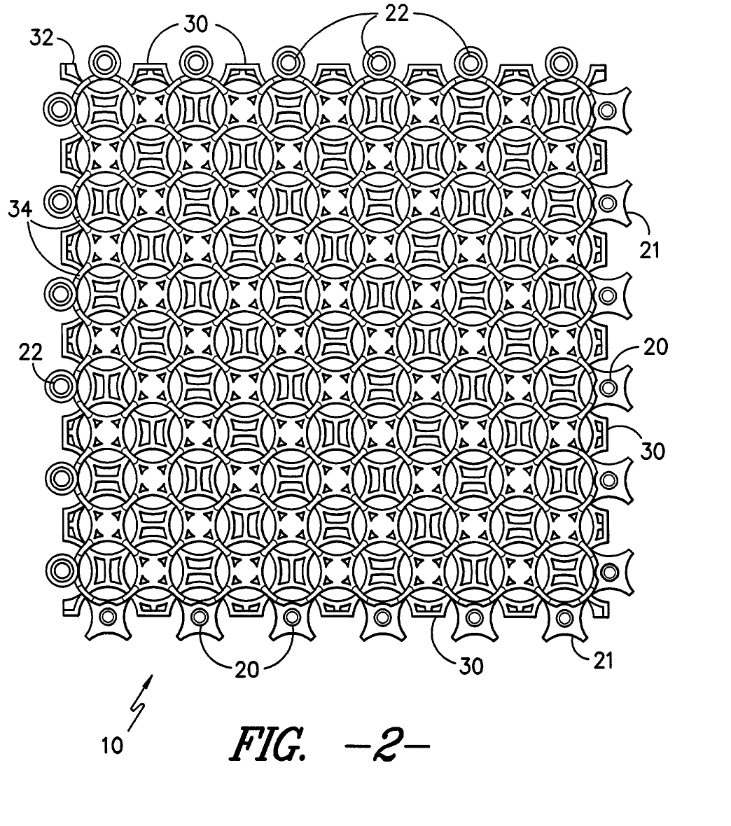

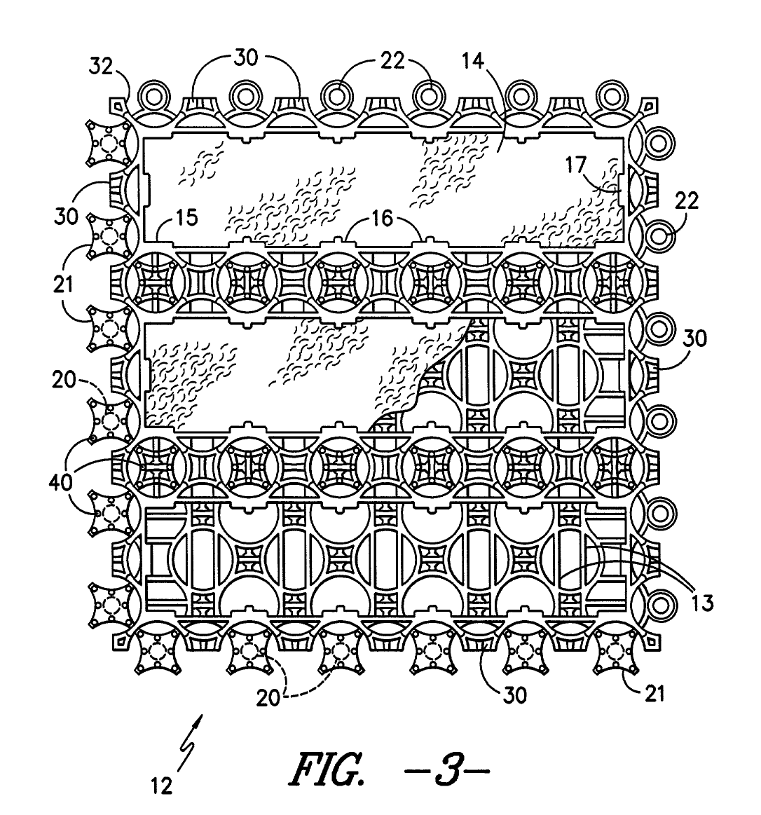

It has been mentioned herein that the individual tiles, which form the mats according to one aspect of the present invention, can be comprised of a thermoplastic elastomer (TPE) or can have a TPE structure into which a textile component, such a carpet strip, is inserted. For purposes of discussion herein, the term “scraper mat” shall refer to a mat that is in the form of an open lattice comprised entirely of TPE and that includes no textile components. Such a structure is illustrated in FIGS. 1 and 2. The term “brush mat” shall refer to a TPE mat whose open lattice structure accommodates a textile component, as illustrated in FIGS. 3 and 4. It should be noted that scraper mat tiles 10 and brush mat tiles 12 have design elements that are unique to each, but feature many of the same essential elements.

The structural features shared by scraper tile 10, as shown in FIGS. 1 and 2, and brush mat tile 12, shown in FIG. 3, include (a) a TPE structure, having an open lattice construction and a plurality of finger-like projections along the face surface; (b) an attachment means for interlocking individual tiles, 10 or 12, to one another or to an edging system, as will be described herein; and (c) integrated reinforcements 30, 32 along the side and corner portions of each tile 10, 12.

Turning specifically now to the Figures, an individual tile 10 comprising a scraper mat is shown in detail in FIG. 1. Tile 10 has a square shape, two adjacent sides having pegs 20 protruding from the underside thereof (see FIG. 2) and the remaining two adjacent sides having corresponding sockets 22. Between each attachment means, whether pegs 20 or sockets 22, is a joint reinforcement 30. Joint reinforcement 30 assists in providing a stable surface along the edges of tiles 10. Corner reinforcements 32 provide a stable surface along the intersection of adjacent tiles 10. Reinforcements 30, 32, which have a vertical height equal to the vertical height of tile 10, also block interstices in the tile lattice design that might otherwise trap the heel portion of high-heeled shoes, etc. The face of tile 10 features upwardly-directed finger-like projections 40 that are positioned in a pattern-wise arrangement and that provide dirt-dislodging functionality.

The back surface of tile 10 is shown in FIG. 2. From this view, pegs 20 of the “male” configuration are visible as projecting (in normal use) downwardly from edge plates 21. The back surface further includes a plurality of integrated ribs 34 that slightly elevate the mat above the floor surface and allow water to flow beneath the mat.

Brush mat tile 12 is shown in FIG. 3. FIG. 3 shows the general arrangement of the TPE lattice into which a textile component 14, having a generally rectangular shape, has been accommodated. The term “end” shall refer to the respective sides of textile component 14 having a short length, while the term “side” shall refer to the respective sides of the textile component 14 having a longer length. Brush mat tile 12 also includes a plurality of non-removable integrated clips 15, 16, 17, having several different profiles for securing textile component 14 into the lattice of tile 12. Corner clips 15 have an L-shaped configuration, end clips 17 have a rectangular configuration, and side clips 16 have a bracket configuration. Textile component 14, which is typically rectangular in shape, may be positioned into the TPE lattice by sliding component 14 beneath integrated clips 15, 16, 17.

Textile component 14 can be, for example, a strip of carpet tile. The carpet tiles that comprise textile component 14 are tufted with coarse nylon as well as monofilament nylon. Unlike traditional carpet tiles, the desired surface texture for textile component 14 is abrasive. The preferred ratio of conventional nylon to monofilament nylon is on the order of ten to one, although other ratios may be used as conditions demand. One example of suitable dimensions for textile component 14 is a thickness of about 0.44 inches, a width of about 1.5 inches, and a length of about 6.6 inches, although other dimensions may be used as conditions demand.

FIG. 3 depicts several of the features used in scraper tile 10, namely pegs 20, sockets 22, joint reinforcements 30, corner reinforcements 32, and finger-like projections 40. However, tile 12 further includes a series of paired back reinforcements 13 that offer additional structural support to tile 12.

As mentioned above, tiles 10, 12 have a molded lattice structure comprised of thermoplastic elastomer. Thermoplastic elastomer (TPE) is a preferred substance for the tiles because of several characteristics inherent to the elastomer. Most importantly, perhaps, is the ability to mold the elastomer into a functionally useful and durable structure. The TPE has an improved coefficient of friction as compared with alternative mat materials. This feature makes mats from tiles 10, 12 less likely to slide during use, particularly when subjected to heavy traffic or rolling transport (such as from hand trucks or carts), or under wet conditions. Another benefit of using TPE is the tendency of the structure to be thermally stable, thereby resisting contraction or expansion as may occur in conventional mats that are subjected to temperature fluctuations. This thermal stability is especially important considering the mats of the present invention are typically placed in close proximity to an entryway, thus exposing the mat to a variety of weather conditions. Another important advantage of this preferred material is the recyclability of TPE. At the end of the mat's useful life, it is preferable to dispose of the mat by recycling rather than landfilling.

The second similarity between scraper tile 10 and brush mat tile 12 is their common system for the interlocking of adjacent tiles (10 or 12) or of individual tiles (10 or 12) with complementary border strips (50 and 52, as shown in FIG. 4). Tiles 10, 12 may each have a square shape having sides of a convenient length; in a preferred embodiment, side lengths on the order of 8.3 inches (20 centimeters) may be used. Tiles 10, 12 are formed to be mutually interlocking along their edges to form half-lap joints between adjacent tiles. Alternatively, shapes having aspect ratios that are conducive to tiling in a mathematical sense (e.g., rectangular shapes having aspect ratios of 2:1 or 3:1) may be used.

Two adjacent sides of each tile have a “male” configuration, with a row of downwardly projecting mushroom-headed pegs 20. Each of these pegs 20 is formed as part of a laterally projecting edge plate 21, which is confined to the upper half of the thickness of the tile and from which project pegs 20 (downwardly, in normal operation) as well as finger-like projections 40 (upwardly, in normal operation). Pegs 20 of the “male” configuration project downwardly through the lower half of the vertical height of the tile. The remaining sides of the tile are formed in a “female” configuration that has a row of laterally projecting sockets 22, appropriately dimensioned to accommodate pegs 20, which sockets 22 are open from above and whose full height is confined to the lower half of the thickness of the tile.

It has been found that six pegs 20 or sockets 22 per tile side are particularly effective in securing tiles (10 or 12) to adjacent tiles and to border strips 50, 52, although other numbers of pegs 20 or sockets 22 may be used so long as the numbers and spacings of pegs and sockets are compatible. The inclusion of “male” and “female” components on each tile allows any number of tiles to be interlocked to create a mat having any desired dimensions, so long as the desired dimension can be spanned using an integral number of tiles or the tile(s) may be cut to accommodate the desired space. Border strips 50, 52 either have a “male” configuration or a “female” configuration, each being complementary to the respective “female” and “male” tile sides.

Thus, each mat tile has two kinds of edge, namely “socket edges” and “peg edges,” each being respectively complementary with the other. Tiles 10, 12 can be interconnected by bringing these complementary types of edge into mutually overlapping engagement, and then pressing the overlapping edges together such that pegs 20 on the edge of one tile enter sockets 22 in the complementary edge of the other tile with the mushroom head of peg 20 becoming securely engaged in ring 23 (see FIG. 12). The mushroom-headed pegs 20 latch into respective sockets 22 and so lock the two tiles together along their adjacent edges. Mats of a desired size can be built up by interconnecting suitable numbers of tiles (as shown, for example, in FIG. 4). However, the outer edges of the resultant mat will always present projections 40 (attached to edge plate 21), sockets 22, or both, thus enabling the connection of further tiles (as mat extensions) or the connection of an edging system.

Because the unfinished edges of the mat present an aesthetically displeasing appearance, alternatives are provided. For instances in which the mat is not recessed in a mat holding well, or in which the mat is not used as part of the primary floor surface of an entryway, an edging system is provided as described herein. In instances in which the mat becomes the primary floor surface, or in which the mat is surrounded by a recessed area, such an edging system may be unnecessary. In these latter instances, it may be desirable to use a utility knife to remove the uncovered pegs 20 and sockets 22 from the structure, such that a straight edge is created. The straight edge enables the modified mat to snugly fit the dimensions into which it is placed.

FIG. 4 shows the edging system, as it is attached to textile brush mat 6 formed from a plurality of tiles 12. The edging system includes border strips 50, 52, which carry pegs 20 and sockets 22 that cooperatively join respective sockets 22 and pegs 20 along the edge portions of the mat. It should be noted that border strips 50, 52 are equally compatible with scraper tiles 10, to create an edged scraper mat (not shown in the Figures).

Border strips 50, 52 include, as well as integrated corner portions, an integrated means for attachment to the mat tiles. The comers of the finished mat (such as mat 6, in FIG. 4) are created by attaching border strips 50, 52 to the respective edges of mat 6, aligning the mitered edges of border strips 50, 52 with one another, and securing the corner portions with a mechanical clip 70. Mechanical clip 70 can also be used to secure border strips 50, 52 that have been placed in abutting relationship to one another to create a custom-sized mat. Border strips 50, 52 and mechanical clip 70 will each be discussed in more detail in regard to later Figures.

FIG. 5 is a cross-sectional view of edged mat 6 of FIG. 4, as taken along line 5-5 of FIG. 4. From the outermost edge, border strip 50 is shown, having a beveled edge 60. Edge plate 21 is shown with finger-like projections 40 on the upwardly facing surface. Side clip 16 assists in securing textile component 14 in mat 6. The pattern-wise arrangement of projections 40 is also shown.

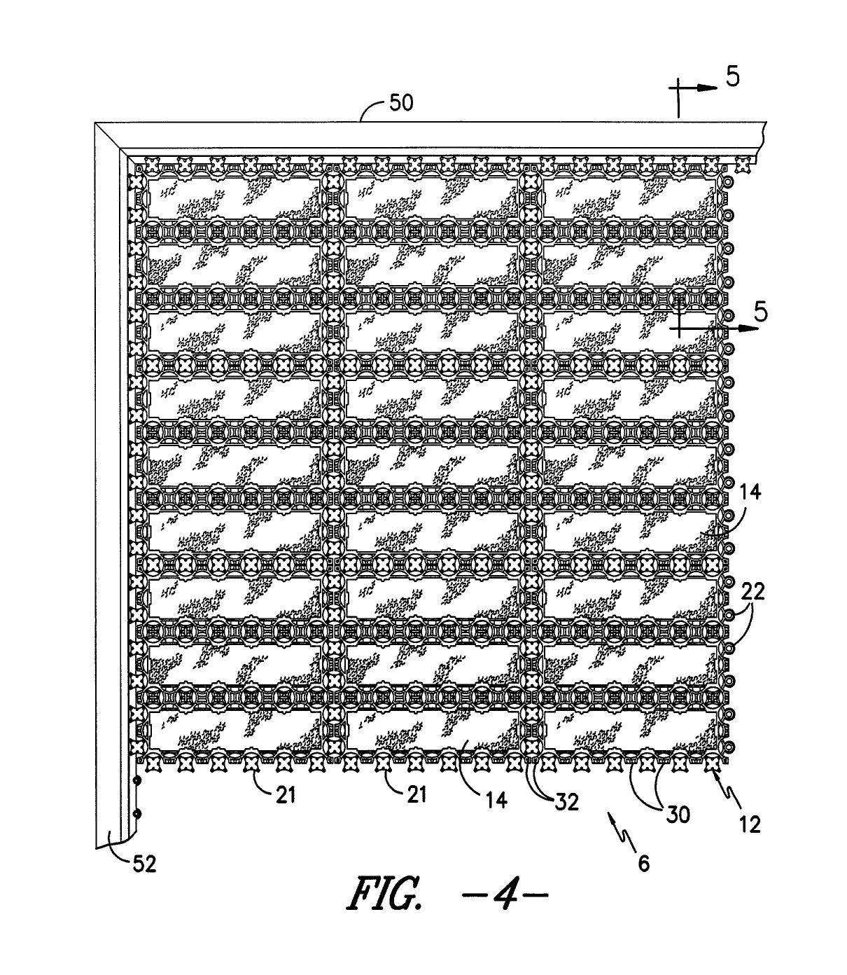

FIG. 6 shows a mitered joint in which border strip 50 is joined with border strip 52, by means of mechanical clip 70. Mechanical clip 70 is placed on the back of border strip 50, 52 into a slightly recessed area adjacent to the mitered edge. Border strip 50 has pegs 20 incorporated therein, while border strip 52 includes corresponding sockets 22. Border strips 50 and 52 have a plurality of integrated border reinforcements 56, in both a vertical and horizontal direction. Corner cut line 58 is also shown in FIG. 6, and will be discussed in greater detail below.

FIG. 7 illustrates mechanical clip 70. Mechanical clip 70 is comprised of glass-filled nylon and has integrated, serrated teeth 72. Mechanical clip 70 must be opened slightly, by stretching the pre-tensioned jaws 74, in order to span the width of raised portions adjacent cut lines 54, 58. Mechanical clip 70 is then pushed securely over cut lines 54, 58. Teeth 72 engage border strips 60, 52 and resist sliding. Without these integrated teeth 72, mechanical clip 70 would tend to slide out of position, causing a gap to form between the connected sections, thereby adversely affecting the appearance of mat 6. Further, the loosened border strip 50 or 52 could cause a trip hazard.

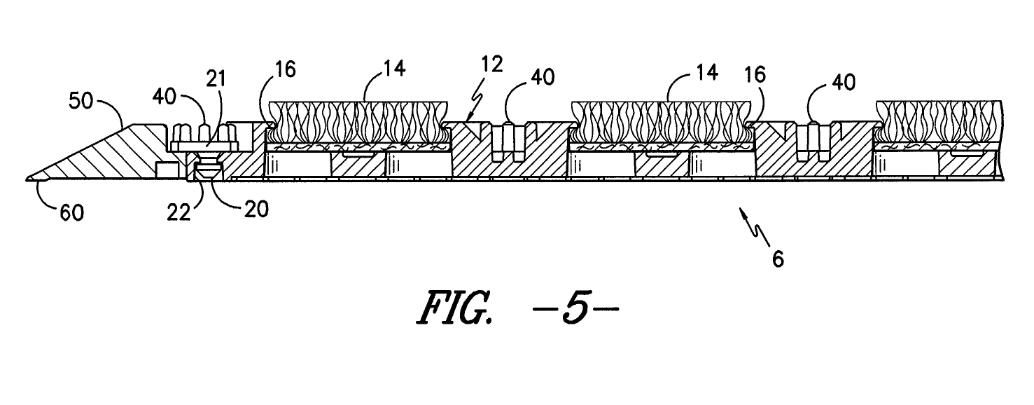

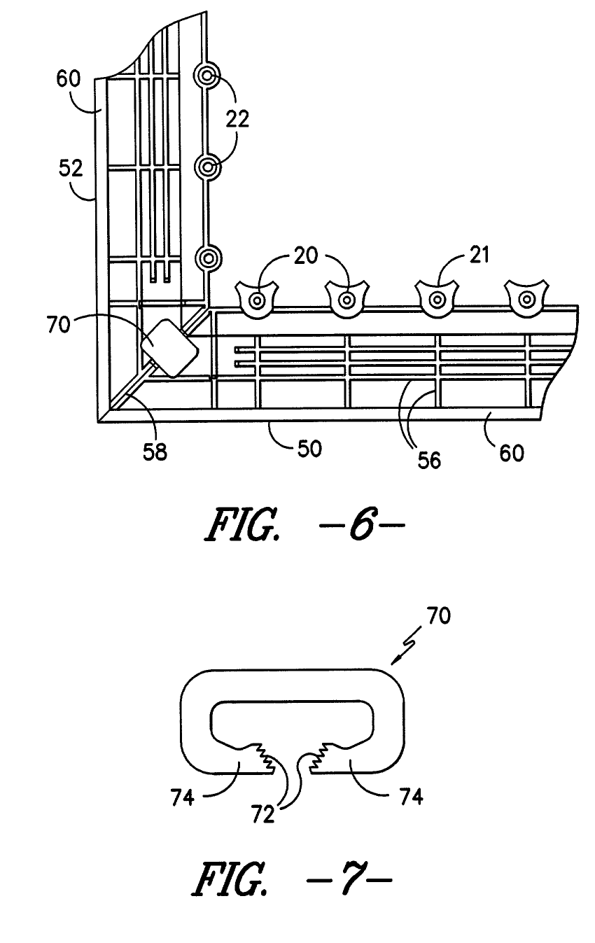

FIG. 8A shows a plan view of the face of border strip 50. The face view of edge plate 21 is also shown. FIG. 8B shows a plan view of the back of border strip 50, having a row of pegs 20 along one edge. On the opposite edge of border strip 50 is a beveled border edge 60, border edge 60 being sloped at a slight angle to ensure consistently flat contact between border strip 50 and the floor (or other surface on which a mat is laid). To accommodate the desire for mats of custom sizes, border strip 50 includes integrated cut lines 54, 58 that facilitate the cutting of strip 50 to a desired length or configuration. Cut line 54 is a straight cut line, while cut line 58 is a diagonal cut line. Straight cut line 54 is used to shorten border strip 50 and enable an additional border strip 50 to be placed in abutting relationship with the initial border strip 50. Diagonal cut line 58 is used to shorten border strip 50 and to create a new comer. On either side of cut lines 54, 58 are slightly raised linear portions that are capable of receiving mechanical clip 70 to secure adjacent border strips. Along the back of border strip 50 is an integrated system of border reinforcements 56, which extend along the back of border strip 50 in a vertical and horizontal direction.

FIG. 9 is a cross-sectional view of FIG. 8B, as taken along line 9-9. The slight bevel of border edge 60, intended to provide a mating surface between border strip 50 and the floor, is visible. Further, border reinforcements 56 are also visible, such border reinforcements 56 having a vertical height that is equivalent to the dimensions of border strip 50 at the point at which border reinforcements 56 are attached. Peg 20 is shown at the topmost portion of FIG. 9 with finger-like projections 40 on the face side of edge plate 21.

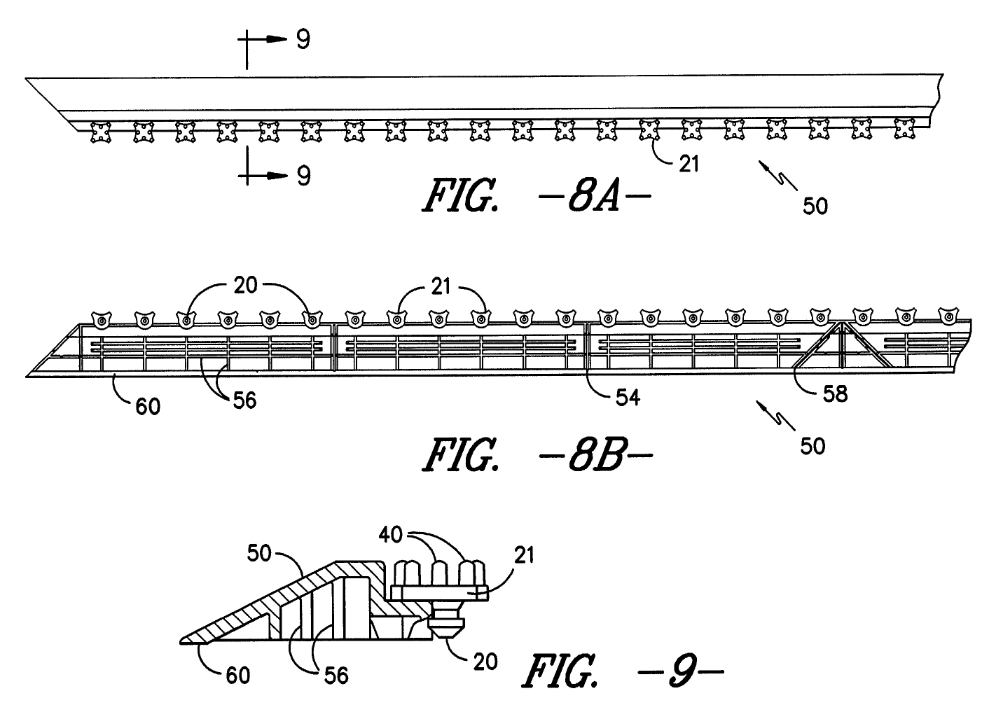

FIG. 10A is a plan view of the face side of border strip 52, including a row of sockets 22 on one side. Fig. 10B is a plan view of the back side of border strip 52. As with border strip 50, straight cut lines 54, diagonal cut lines 58, and border reinforcements 56 are incorporated in border strip 52.

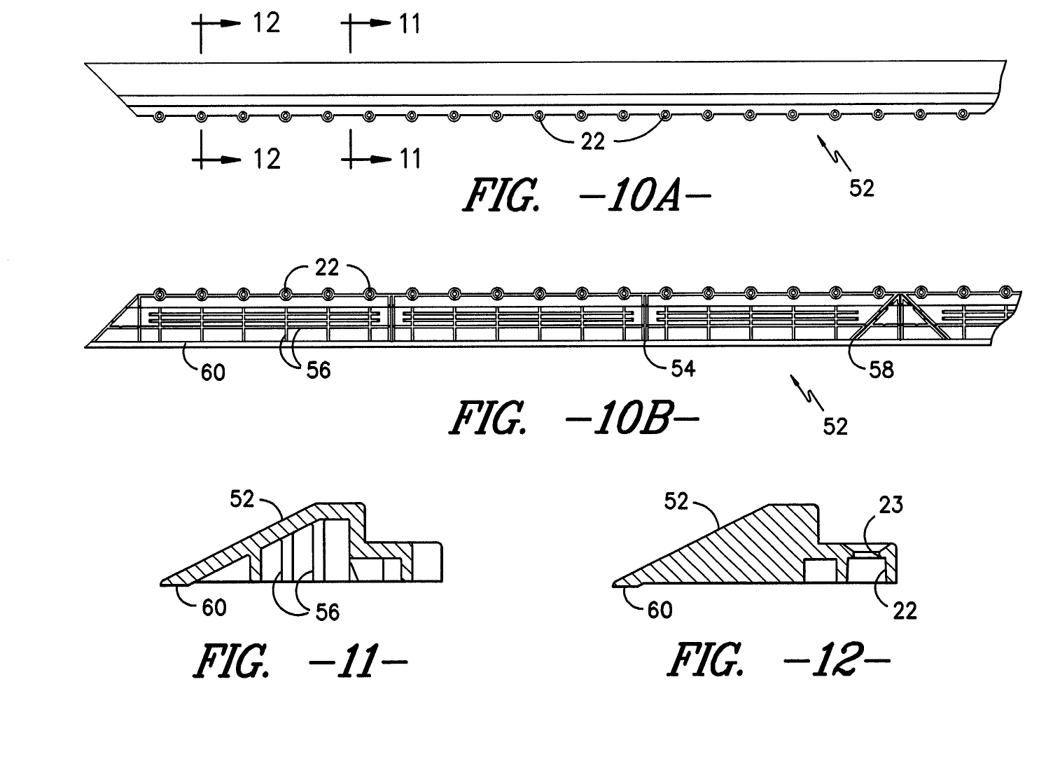

FIG. 11 is a cross-sectional view taken along line 11-11 of FIG. 10A, between adjacent sockets 22. Border edge 60 and border reinforcements 56 can be configured similarly to border strip 50. FIG. 12 is a cross-sectional view taken along line 12-12 of FIG. 10A, the cross-section being taken through socket 22. The cross-section of socket 22 is visible, as is beveled border edge 60. Constricting ring 23 is sized to co-act with mushroom-headed pegs 20, forming a “snap into place” connection through which border strip 52 may be attached to the appropriate edge of a tile (10 or 12). Ring 23 is a feature of all sockets 22 and provides a “snap into place” functionality for all connections involving pegs 20 and sockets 22.

Border strips 50 and 52 are comprised of molded thermoplastic elastomer and, as a result, have a substantially rigid construction. The length for such strips 50, 52 will depend to some degree upon the dimension of tiles 10 or 12. For square tiles of approximately 8 inches by 8 inches, a length of 48 inches from straight cut line 54 closest the comer to straight cut line 54 closest the opposite comer, excluding the areas of each strip that comprise the corners, have been found to be a useful length. Such strip length will attach six tiles (10 or 12), by the interlocking system previously described.

A kit for making a mat having dimensions of about four feet by about eight feet (4′×8′), using square tiles of about 8 inches per sides, will include 72 tiles (10 or 12), three border strips 50, three border strip 52, and ten mechanical clips 70. In the course of installation, tiles (10 or 12) are interlocked along their complementary edges, after which the complementary border strips 50, 52 are attached in a similar manner. Border strips 50, 52 are secured to one another at their butt edges, as well as their mitered edges, by mechanical clip 70. The finished mat is then placed in an appropriate location.

Scraper mats made from tiles 10 are particularly well suited for outdoor applications, such as the exterior of building entryways. Alternatively, these scraper mats are also ideal for installation as a primary floor covering into an entry foyer of a building. In this application, tiles 10 are installed without border strips 50, 52, and a straight edge (as would be necessary to fit tiles 10 flush against a wall) is created by cutting the protruding pegs 20 or sockets 22 from tiles 10, or cutting tile 10 along any line necessary to create a flush fit. A third application is the installation of the scraper mat into a recessed area in the floor (i.e., a mat holding well), using the same cutting procedure described above. The aforesaid second and third alternatives, with the mat being used as a primary floor covering or being installed into a recessed area, are particularly well suited to the use of tiles 12 that include textile component 14.

Scraper mats formed by assemblies of interlocked tiles 10 (or, in the case of textile brush mats, 12) may be used on floors, on paved surfaces, or on unpaved ground. In all cases, the thickness of the mat should not impede foot or rolling traffic over the mat. The preferred vertical height of the mats is about 0.5 inches, which is the height of standard door jams. Thus, these mats are unlikely to present a trip hazard. The likelihood of tripping over the mat is further decreased by providing a uniform broad edge around the mat (or along one or more selected sides of the mat) that presents a shallow incline from the surface on which the mat is resting to the top surface of the mat proper. Of course, in cases where no border strips 50, 52 are used, the mat is preferably installed to fill the dimensions of a mat holding well or an entire room, thereby minimizing any tripping hazard.

It has been found that using a combination of scraper mats made from tiles 10 and textile brush mats 6 made from tiles 12 is particularly effective in removing dirt from mat users' shoes. Scraper mats may be installed, either with border strips 50, 52, or with cut edges as previously described, at the exterior entryway of a building. Immediately inside the entryway, textile brush mats 6 may be installed, again either with border strips 50, 52, or with cut edges. Beyond the immediate entry area, it may be desirable to install further carpet tiles of the kind that comprises textile component 14. These carpet tiles, which have an abrasive surface, are also capable of removing dirt, and can include aesthetic features, such as colored, patterned, or printed surfaces.

In addition to being useful for dirt removal, it is contemplated that the scraper mat of the present invention could also be used in a variety of settings in which the scraper mat may be subjected to wet conditions. The scraper mat may be used on the decks adjacent to swimming pools and in shower, locker room, or restroom areas. Because of the low coefficient of friction associated with the thermoplastic elastomer, these mats have little tendency to slip, even when wet. Furthermore, it is contemplated that such scraper mats have the capability of being “anti-fatigue” floor coverings, making them ideal for installation into areas where people routinely stand for long periods of time (e.g., a grocery check-out line).

I claim:

1. A mat tile suitable for inclusion in a floor mat, said mat tile being comprised of a thermoplastic elastomer molded in a square shape, having a vertical height and having a lattice construction, wherein said lattice includes a pattern-wise configuration of finger-like projections and wherein each side of said square tile has an integrated row of attachment means, said attachment means capable of securing said mat tile to both adjacent mat tiles and to border strips as may be desired.

2. The mat tile of claim 1 wherein said mat tile has a side length of about 8.32 inches and a vertical height of about 0.5 inches.

3. The mat tile of claim 1 further comprising a corner reinforcement at each comer of said tile, said corner reinforcement having a vertical height that is equal to that of said tile.

4. The mat tile of claim 1 wherein said attachment means comprises a row of downwardly projecting mushroom-headed pegs that are positioned along two sides of said tile and that laterally project from the upper half of the height of said tile, and wherein said attachment means further comprises a row of sockets, said sockets being positioned along the remaining two sides of said tile and laterally projecting from the lower half of the vertical height of said tile, said sockets being complementary to said pegs.

5. The mat tile of claim 4 further comprising a plurality of joint reinforcements along each of said sides, said joint reinforcements being positioned between each of said attachment means, and said joint reinforcements having a vertical height that is equal to that of said tile.

6. The mat tile of claim 1 further comprising a plurality of congruent carpet strips, each of said carpet strips having a length, a width, and a vertical height, each of said carpet strips being inserted into a molded slot in said lattice, said slot having a vertical height that is slightly less than the vertical height of said carpet strip and a width that is slightly greater than the width of said carpet strip.

7. The mat tile of claim 6 wherein each of said carpet strips is secured in said lattice by a series of carpet clips that are integrated into said lattice, said clips being positioned in overhanging relation to the edges of said slot into which said carpet strip is inserted.

8. The mat tile of claim 6 wherein said carpet strip has a length of about 6.62 inches, a width of about 1.5 inches, and a vertical height of about 0.44 inches.

9. The mat tile of claim 6 wherein said carpet strips are comprised of nylon and monofilament fiber at a determined ratio of nylon fiber to monofilament fiber, said monofilament fiber creating an abrasive surface on said carpet strip.

10. The mat tile of claim 9 wherein the ratio of nylon fiber to monofilament fiber is on the order of seven to one.

11. An edging system for a mat comprised of individual tiles, said mat having borders adapted for attachment to complementary edges of said mat, said edging system comprising one or more border strips attachable to selected parts of said mat edges in a self-securing manner, said border strip forming an edge extending along one or more selected edges of said mat.

12. The edging system of claim 11 wherein said border strip includes a row of downwardly projecting mushroom-headed pegs that are positioned along the edge of said border strip that is attached to said mat, said pegs being attachable to complementary sockets along the edge of said mat.

13. The edging system of claim 11 wherein said border strip includes a row of sockets, said sockets being positioned along the edge of said border strip that is attachable to said mat, said sockets being capable of receiving complementary pegs that are positioned along the edge of said mat.

14. The edging system of claim 11 wherein said border strip has a thickness that diminishes from an edge adjacent said mat in an assembled edging system to the opposite edge, which will be the outer edge of the bordered mat, whereby the border strip forms a tapered edge to the mat along one or more selected sides of said mat.

15. The edging system of claim 11 wherein said border strip is comprises of a strip of molded thermoplastic elastomer having a determinate length.

16. The edging system of claim 15 wherein said border strip has a determinate length that approximates the length of six individual tiles.

17. A floor mat comprised of a plurality of individual mat tiles, said mat tiles having a substantially square shape and being connected to one another and being further connected to a plurality of border strips, said mat tiles being connected by an interlocking, attachment means, said attachment means including a row of mushroom-headed pegs that project from the upper half of the vertical height of two adjacent sides of each tile and a row of sockets capable of receiving said pegs that project from the lower half of the vertical height of the remaining two sides of each tile, such that said pegs of one tile are inserted into said sockets of an adjacent tile to attach said tiles, and said border strips have either a row of mushroom-headed pegs or a row of sockets, thus allowing said strips to attach to the complementary attachment means of said tiles in order to form a finished edge extending along the sides of said mat.

18. The floor mat of claim 17 wherein said mat and said border strips are comprised of molded thermoplastic elastomer.

19. The floor mat of claim 17 wherein said mat includes a pattern-wise configuration of finger-like projections that are capable of removing dirt from the soles of mat users' shoes.

20. The floor mat of claim 19 wherein said mat further includes carpet strips that are inserted into each of said mat tiles.
